(19) United States
(12) Patent Application Publication
(10) Pub. No.: US 2007/0108731 A1
(43) Pub. Date: May 17, 2007

(54) Trailer tongue lifting and positioning system

(75) Inventor: Ryan McBroom, Ottawa Lake, MI (US)

Correspondence Address: PURDUE LAW OFFICES;2735 N. HOLLAND-SYLVANIA ROAD, SUITE B-2, TOLDEO, OH, 43615, US

(73) Assignee: Will Enterprises, Ltd., Walbridge, OH (US)

(21) Appl. No.: 11/400,983

(22) Filed: Apr. 10, 2006

Related U.S. Application Data
(60) Provisional application No. 60/728,695, filed on Oct. 19, 2005.

(51) Int. Cl. B60D 1/36

(52) U.S. Cl. 280/477

(57) ABSTRACT

A device operable to position a trailer for attachment to or removal from a hitch ball on a towing vehicle is disclosed. The device is operable to lift a trailer tongue above a hitch ball, without hitting the trailer tongue on the hitch ball, and reposition the trailer tongue so that it may be lowered directly onto the hitch ball. The device is also operable to lift a trailer tongue of a trailer to detach it from a hitch ball and to reposition the trailer tongue so that it may be lowered to the ground without hitting the trailer tongue on the hitch ball. The device includes a cable spool and a cable and a boom supported for movement between a first, hitch clearing position and a second, trailer connecting or disconnecting position.

### BACKGROUND OF THE INVENTION

1. Field of the Invention.

The present invention relates generally to a system for positioning a towed vehicle relative to a towing vehicle so that the towed vehicle and the towing vehicle may be connected together or disconnected.

2. Description of the Prior Art

Humans have been connecting trailers to towing vehicles for many, many decades and, if one is willing to count a horse as a towing vehicle, for centuries. Trailers today are designed so that they have a trailer tongue weight meaning that when the trailer tongue is unsupported, the trailer tongue drops to the ground. It is known to lift a trailer tongue and maneuver the trailer tongue until the trailer coupler is positioned directly above a trailer hitch ball, pintle hitch or the like, whereupon the tongue is lowered so that the coupler may be connected to the hitch ball or pintle hitch or the like. Also known are trailer jacks which are devices that are connected to a trailer tongue and they include a mechanism for jacking up the trailer tongue. Some trailer jacks include a wheel or wheels to facilitate the chore of positioning the trailer tongue over the hitch ball. A number of devices for positioning a trailer coupler are described in prior including U.S. Pat. Nos. 3,596,925, 4,186,938, 4,186,939, 4,545,595, 4,807,899, 4,881,864, 5,048,854, 5,072,962, 5,085,408, 5,277,446, 5,314,202, 5,405,160, 5,882,029, 5,938,227, 6,086,083, 6,193,258, 6,494,477, 6,511,089, 6,644,680 and 6,821,075.

### SUMMARY OF THE INVENTION

The present invention is based upon the discovery of a vehicle based trailer tongue lifting and positioning system The system includes a vehicle based winch and a boom. A cable associated with the winch has a connector for connecting the cable to a cooperating connector provided on the trailer tongue. With the trailer near the vehicle, the cable connector is connected to the cooperating connector and the winch is activated and the cable is wound onto a the spool of the winch, pulling cable past the tip of the boom and bringing the trailer tongue connector to a position below the end of the boom. The winch remains activated so that the cable lifts the trailer tongue off of the ground until it clears the hitch ball. The end of the boom is then repositioned so that trailer tongue coupler is positioned over the trailer hitch ball and the winch is reversed so that gravity brings the coupler down onto the hitch ball whereby the trailer may be connected to the hitch. The process is reversed to remove the trailer coupler from the hitch ball. As used herein, hitch ball will refer to a hitch ball, pintle hitch or any other vehicle based trailer hitch to which a trailer may be hitched. Several embodiments of a system according to these general principals are disclosed.

Accordingly, it is an object of the invention to eliminate the need to manually lift the tongue of a trailer in order to connect a trailer to or to disconnect a trailer from a towing vehicle or a vehicle hitch.

It is a further object of the invention to provide a system that consistently and automatically positions a trailer tongue coupler over a trailer hitch ball or the like.

It is yet another object of this invention to provide such a system that takes up very little space.

These and other objects of the invention will no doubt be apparent to those familiar with this field from reading and considering the detailed description that follows.

### BRIEF DESCRIPTION OF THE SEVERAL VIEWS OF THE DRAWING

FIG. 1 is a perspective view of a system according to the present invention for connecting a trailer to a towing vehicle.

FIG. 2 is a side view of the system shown in FIG. 1 at an intermediate stage in the process of connecting the trailer to the towing vehicle.

FIG. 3 is a side view of the system shown in FIGS. 1 and 2 at the end of the process in which the trailer has been connected to the towing vehicle.

FIG. 4 is a side view, partially in cross-section, of a second embodiment of a system according to the invention for connecting a trailer to a towing vehicle.

FIG. 5 is a side view of the system shown in FIG. 4 at an intermediate stage in the process of connecting the trailer to the towing vehicle.

FIG. 6 is a side view of the system shown in FIGS. 4 and 5 at the end of the process in which the trailer has been connected to the towing vehicle.

FIG. 7 is a view, partially in cross section, of a third embodiment of a system according to the invention.

FIG. 8 is a cross sectional view taken along the 8-8 of FIG. 7.

FIG. 9 is a cross sectional view taken along the 9-9 of FIG. 7.

FIG. 10 is a view taken along the line 10-10 of FIG. 7.

FIG. 11 is an exploded perspective view of a universal bracket mount system for supporting apparatus according to the invention or other apparatus on a trailer hitch.

FIG. 12 is a side view of apparatus according to a fourth embodiment of the present invention supported on a hitch with the bracket shown in FIG. 11, during the initial steps of use.

FIG. 13 is a side view of the apparatus shown in FIG. 12 during the lifting step.

FIG. 14 is a side view of the apparatus shown in FIG. 12 during the step of lowering the trailer tongue to connect it to the hitch ball.

FIG. 15 is a perspective view of one of two side plates of a second embodiment of a universal bracket mount system.

### DETAILED DESCRIPTION OF THE PREFERRED EMBODIMENTS

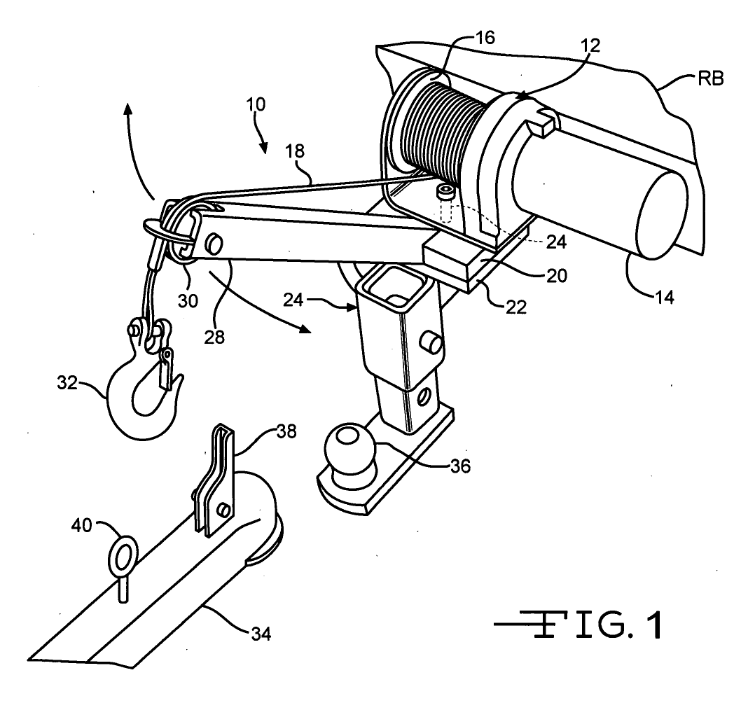

Referring now to FIGS. 1, 2 and 3, apparatus for connecting a trailer (not shown) to a towing vehicle (not shown) having a rear bumper RB (FIG. 1) is indicated generally at 10. The apparatus 10 comprises a conventional winch assembly 12 which, in turn, comprises a motor 14, a cable spool 16 (FIG. 1) and cable 18. The winch assembly 12 is secured to a base plate 20 which is, in turn, mounted on a mounting plate 22. A pin 24 extends through the base plate 20 into the mounting plate 22 and allows for rotational movement between the plates 20 and 22. The mounting plate 22 is secured to a vehicle hitch which, as illustrated, comprises a drop ball hitch 24 adapted to be releasably received in a receiver tube 26. The mounting plate 22 can be secured to the hitch 24 by welding or by fasteners (not shown) or by some combination. The winch base plate 20 and, with it, the winch assembly 12, can pivot relative to the mounting plate 22 and the hitch 24. A boom 28 is connected to the base plate 20 and extends rearwardly and upwardly therefrom and is set to pivot therewith relative to the mounting plate 22 and the hitch 24. The base plate 20 and, with it, the winch assembly 12 and the boom 28, pivot, relative to the hitch 24, between a first, aligned position shown in FIGS. 1, 2 and 3 to a second position (not shown) which is described below.

The cable 18 extends from the spool 16 to the tip of the boom 28 and over a pulley 30 which is supported on the tip of the boom 28. The end of the cable 18 is looped and secured in the loop is a hook 32. Adjacent to the drop ball hitch 24 is a trailer tongue coupler 34 which would be secured to a trailer (not shown). The coupler 34 is designed to go over a tow ball 36 provided on the drop ball hitch 24 in a known manner so that a latch 38 may be pivoted to raise a retainer (not shown) inside of the coupler 34 to abut a lower portion of the ball 36 to keep the coupler 34 secured to the ball 36. A connector 40 in the form of a hook eye is secured to the coupler 34 and extends upwardly therefrom. The operation of the apparatus 10 will now be described.

As a preliminary matter, the mounting plate 22 is secured to a portion of the drop ball hitch 24 with any suitable hardware (not shown) or, as suggested above, by welding. As a further preliminary matter, the connector 40 is positioned on the trailer or on the coupler 34 and connected thereto. The position of the connector 40 is set so that, when the hook 32 is engaged with the connector and the cable is wound onto the spool 16 so that the trailer tongue is raised off of the ground, the mounting plate 20 can be pivoted or rotated to a position where the connector 40 is aligned with the with the tow ball 36. Once the position of the connector 40 is set, connecting the coupler 34 to the tow ball is simple and can be accomplished by one person, no matter how heavy the tongue weight of the associated trailer is.

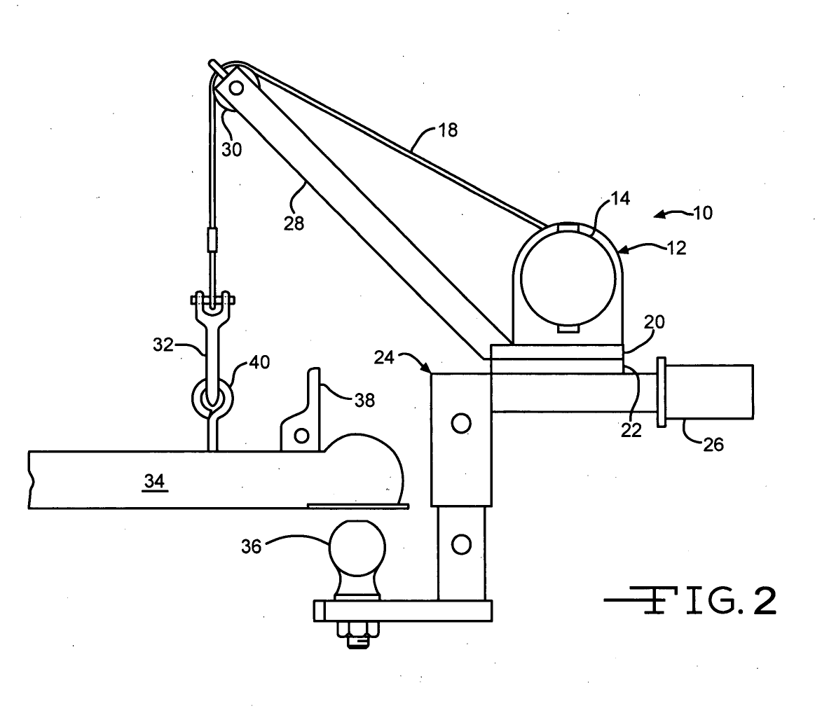

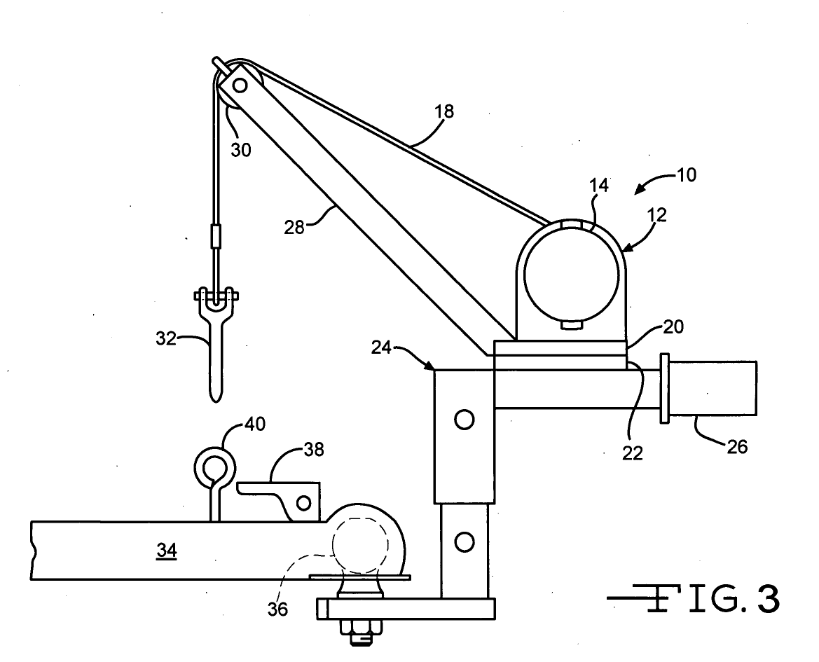

With the trailer not connected to the towing vehicle, the vehicle is positioned so that the hitch 24 is adjacent to the coupler 34. No precision is required in so positioning the towing vehicle and a distance of several feet between the coupler 34 and the ball 36 is easily accommodated. One simply engages the hook 32 in the connector 40, releasing as much cable 18 from the spool 16 as is needed to accomplish this. The base plate 20 is rotated or pivoted on the mounting plate to a second position (not shown) in which the tongue of a trailer with the connector 40 supported on the hook 32 can be raised without the trailer tongue striking or bumping the drop ball hitch. With the hook 32 so connected, the winch 12 is activated to wind cable 18 onto the spool 16. As the cable 18 is wound onto the spool 16, the trailer is drawn towards the apparatus 10 until the connector 40 is positioned directly or nearly directly beneath the pulley 30 at the end of the boom 28. As more of the cable 18 is wound onto the spool 16, the trailer tongue (not shown) connected to the coupler 34 will be lifted off off of the ground until it has achieved the height shown in FIG. 2 relative to the ball 36. At about this point, the winch 12 is deactivated to stop the winding of the cable 18 onto the spool 16 and the lifting of the trailer tongue, and the base plate 20 is rotated, relative to the mounting plate 22, to the first position shown in FIGS. 1, 2 and 3 where the coupler 34 is positioned over the ball 36 so that cable 18 can be unwound from the spool 16 thereby lowering the coupler 34 onto the ball 36 as shown in FIG. 3. The latch 38 is then pivoted to the locking position shown in FIG. 3. Additional cable 18 can then be unwound so that there is slack enough in the cable 18 to permit one to remove the hook 32 from the connector 40. The process can be reversed in order to remove the trailer tongue coupler 34 from the ball 36. Alternatively, the latch 38 can be pivoted to the release position shown in FIG. 2 and the coupler 34 can be manually removed from the ball 36.

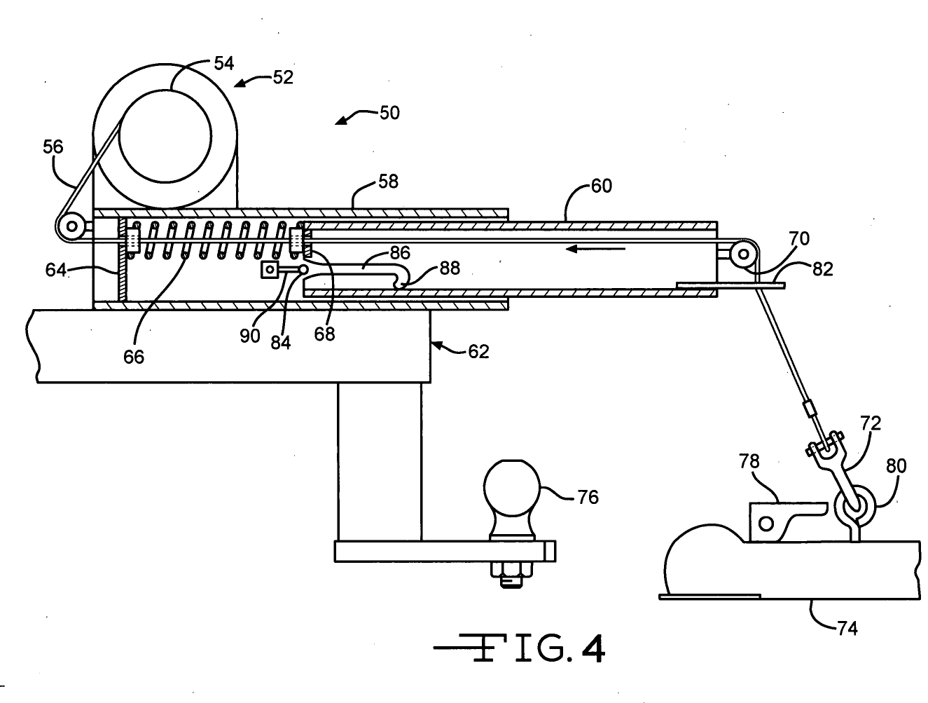

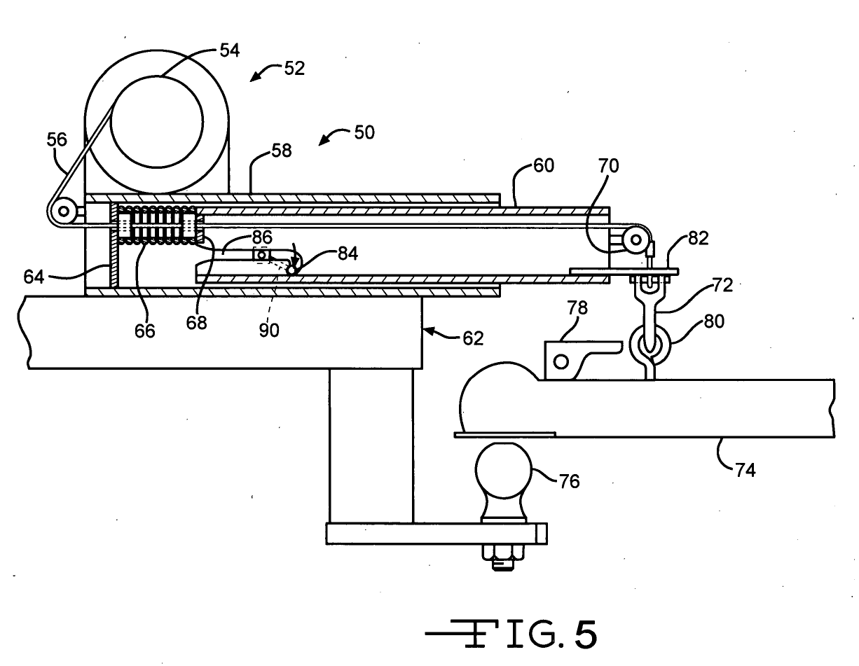

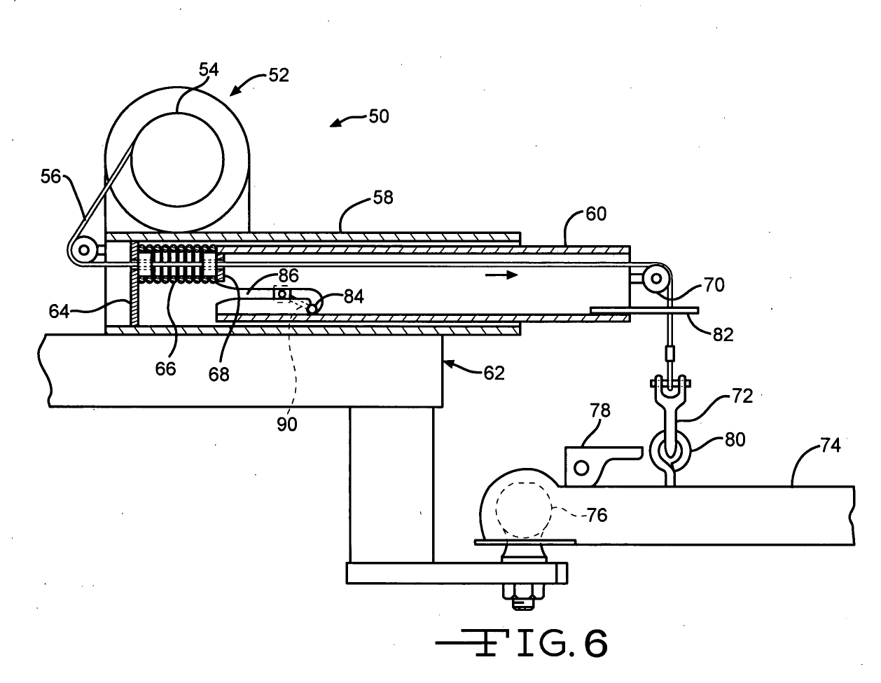

Referring now to FIGS. 4, 5 and 6, apparatus for connecting a trailer (not shown) to a towing vehicle (not shown) according to a second embodiment of the invention is indicated generally at 50. The apparatus 50 comprises a conventional winch assembly 52 which includes a cable spool 54 and cable 56. The winch assembly 52 is secured to a stationary barrel 58 in which a movable boom 60 is mounted for movement between a first, extended position shown in FIG. 4 and a second, retracted position shown in FIGS. 5 and 6. The stationary barrel 58 is secured to a vehicle hitch which, as illustrated, comprises a drop ball hitch 62 adapted to be releasably received in a receiver tube (not shown). The barrel 58 can be secured to the hitch 62 by welding or by fasteners (not shown) or by some combination. The boom 60 is slidably received within the barrel 58. A rear portion of the barrel 58 is at least partially closed by a barrel spring mount 64 which supports one end of a spring 66. The other end of the spring 66 is supported by a boom spring mount 68 that is supported on the rear end of the boom 60. The spring 66 is operable to bias the boom 60, relative to the barrel 58, to move from the second, retracted position (FIGS. 5 and 6) to the first, extended position (FIG. 4).

The cable 56 extends from the spool 54 to the tip of the boom 60 and over a pulley 70 which is supported on the forward tip of the boom 60. The end of the cable 56 is looped and secured in the loop is a hook 72. A trailer tongue coupler 74, which would be secured to a trailer (not shown), is designed to go over a tow ball 76 provided on the drop ball hitch 62 in a known manner so that a latch 78 on the coupler 74 may be pivoted to raise a retainer (not shown) inside of the coupler 74 to abut a lower portion of the ball 76 to keep the coupler 74 secured to the hitch 62. A connector 80 in the form of a hook eye is secured to the coupler 74 and extends upwardly therefrom. The operation of the apparatus 50 will now be described.

As a preliminary matter, the barrel 58 is secured to a portion of the drop ball hitch 62 with any suitable hardware (not shown) or, as suggested above, by welding. As a further preliminary matter, the connector 80 is positioned on the trailer or on the coupler 74 and connected thereto. The position of the 80 is set so that, when the hook 72 is engaged with the connector 80, and when the cable 56 is wound onto the spool 54 so that the trailer tongue and coupler 74 are raised off of the ground, and when the boom is retracted to the second, retracted position, the coupler 74 is positioned directly over the tow ball 76. Once the proper position of the connector 80 is determined, it is connected to the trailer tongue and, preferably, to the coupler 74, as shown.

With the trailer not connected to the towing vehicle, the vehicle and/or the trailer is positioned so that the hitch 62 is adjacent to the coupler 74. No precision is required in so positioning the towing or towed vehicle and a distance of several feet between the coupler 74 and the ball 76 is easily accommodated. One simply engages the hook 72 in the connector 80, releasing as much cable 56 from the spool 54 as is needed. The boom 60 is in the first, extended position in which the tongue of a trailer, with the connector 80 supported on the hook 72, can be raised above the tow ball 76 without the trailer tongue striking or bumping the drop ball hitch 62. With the hook 72 so connected, the winch 52 is activated to wind cable 56 onto the spool 54 and moving the cable 56 in the direction indicated by the arrow in FIG. 4. As the cable 56 is wound onto the spool 54, the trailer is drawn towards the apparatus 50 until the connector 40 is positioned directly or nearly directly beneath the pulley 70 at the end of the boom 60. As more of the cable 56 is wound onto the spool 54, the trailer tongue (not shown) connected to the coupler 74 will be lifted off of the ground until it has achieved the height shown in FIG. 5 relative to the ball 76 and the boom 60. At about this point in the winding of the cable 56 onto the spool 54, a portion of the hook 72 engages a stop plate 82 so that further movement of hook 72 towards the pulley 70 is prevented. Further winding of cable 56 onto the spool 54 will effect movement of the boom from the second, extended position (FIG. 4) to the retracted position (FIG. 5), as indicated by the arrow in FIG. 4.

As the boom 60 is retracted, and as it reaches the retracted position, a stop lever pin 84 enters a slot 86 formed in a portion of the boom and the pin 84 moves along the slot 86 until it reaches a slot recess 88 (FIG. 4) into which it falls or moves under a biasing element (not shown) or into which it is manually moved. The pin 84 is supported on a stop lever 90 which is pivotally attached to and supported on the barrel 58 for pivotal movement between a first, sliding position (FIG. 4) and a second, locking position (FIGS. 5 and 6) where the pin 84 is received in the slot recess 88 when the boom 60 is in the first, retracted position. As shown in FIG. 5, with the boom 60 in the retracted position and the stop lever pin engaged in the slot recess, the coupler is positioned above the tow ball 76. Winding of the cable 56 onto the spool 54 is stopped and, with the pin 84 locking the boom 60, relative to the barrel 58, in the retracted position, cable 56 is unwound from the spool 54 thereby lowering the coupler 74 onto the tow ball 76. Then, the hook 72 is disconnected from the connector 80, the latch 78 is latched and the trailer is towed in the normal fashion. It is preferred that the winch be activated to spool up any excess slack cable.

The apparatus 50 can be used to aid in removing the trailer from the hitch. If the hook 72 has been removed from the connector 80, it is attached or reattached to the connector 80 and the winch 52 is activated to wind up cable until the coupler 74 is raised off of the ball 76 and the hook 72 abuts the stop plate 82. Continued activation of the winch 52 will help release the pin 84 for movement from the second, locking position to the first, sliding position. With the pin 84 is the first position, the winch 52 is activated to unwind cable 56 from the spool 54 so that the boom 60, under the action of the spring 66, moves to the extended position (FIG. 4). When the boom 60 reaches the extended position, more cable 56 is unwound from the winch 52 so that the hook 72 and the coupler 74 and the trailer are lowered towards the ground under the control of the winch 52. When the coupler 74 reaches the ground, cable is unwound to provide slack and the hook 72 is disconnected from the connector 80, thereby disconnecting the trailer from the towing vehicle.

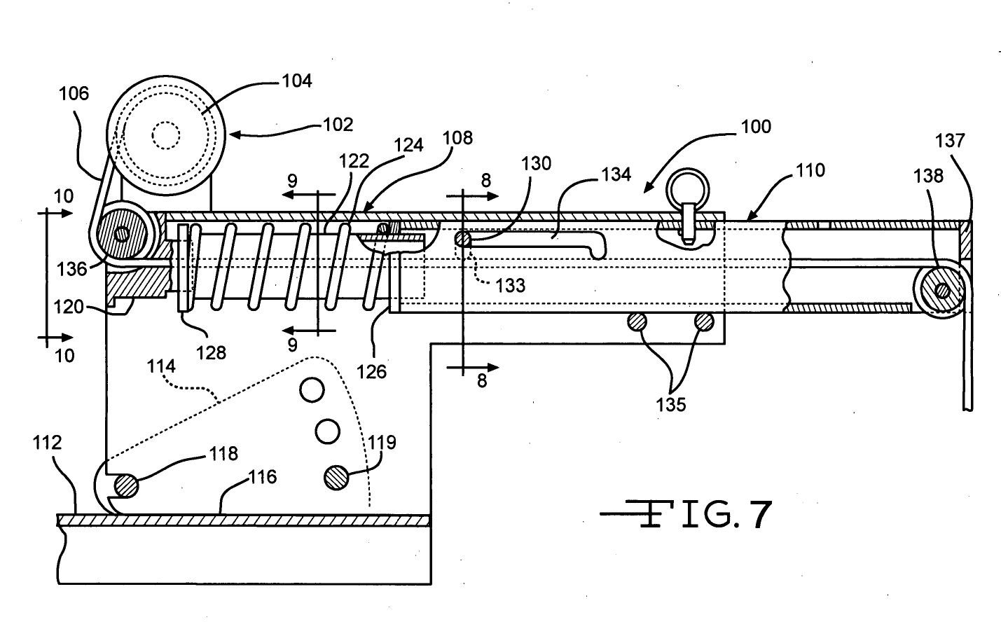

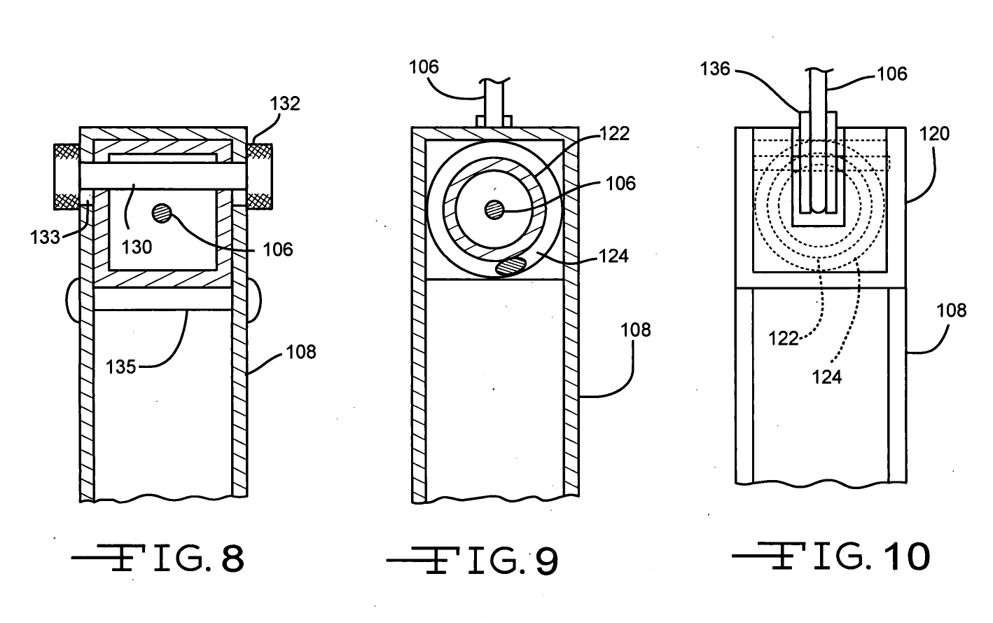

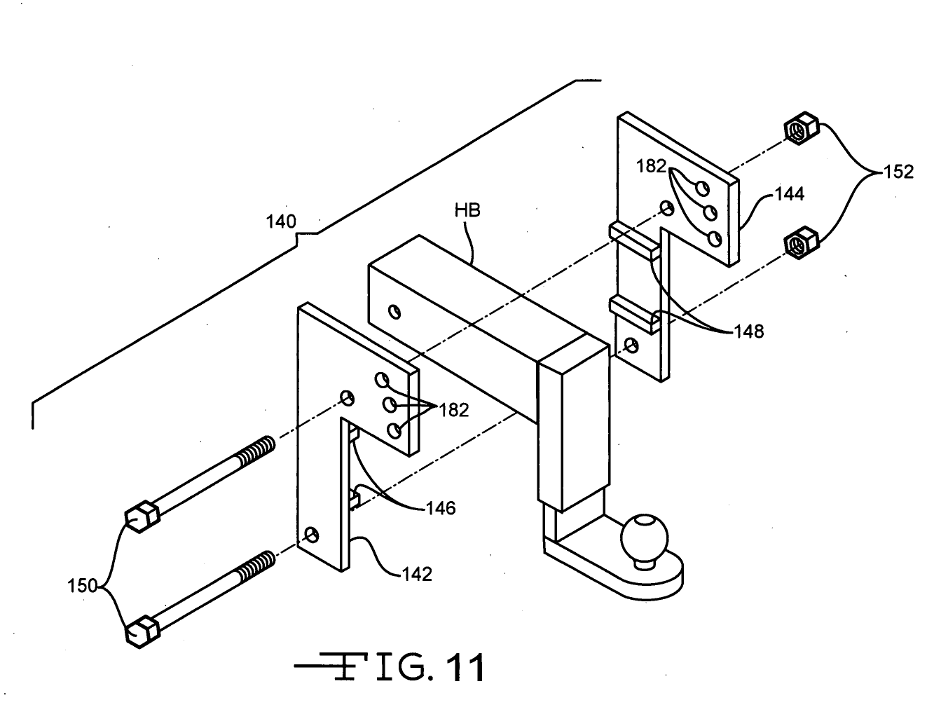

Referring now to FIGS. 7 through 10, apparatus for connecting a trailer (not shown) to a towing vehicle (not shown) according to a third embodiment of the invention is indicated generally at 100. The apparatus 100 comprises a conventional winch assembly 102 which includes a cable spool 104 and cable 106. The winch assembly 102 is secured to a stationary barrel 108 in which a movable boom 110 is mounted for reciprocating movement between a first, extended position shown in FIG. 7 and a second, retracted position (not shown). The stationary barrel 108 may be secured directly to a vehicle hitch 112 or, preferably, is pivotally supported on a barrel support comprising one and preferably two side plates 114 which are secured to a base plate 116 that is adapted to rest on the hitch 112 or a receiver tube (not shown). A pivot pin 118 extends through the side plate or plates 114 and through the side walls of the barrel 108 so that the barrel 108 can pivot about the pin 118 from a first position shown in FIG. 7 to a second position where the boom 110 is raised above the position shown for it in FIG. 7 and to a third position, if desired. The barrel 118 is secured in the first, second, third or other pivoted position by a pivot locking pin 119 that also extends through the side plate or side plates 114 and the barrel 108. The barrel 108 or, preferably, the barrel support, can be secured to the hitch 112 by welding (not shown) or by fasteners (not shown) or by some combination or by other suitable means. The boom 110 is slidably received within the barrel 118. A rear portion of the barrel 108 is at least partially closed by a barrel spring slide mount 120 which supports one end of a spring slide 122 on which a spring 124 is supported. The other end of the spring slide 122 extends through an opening in a boom end spring plate 126 so that one end of the spring 124 abuts the plate 126. The other end of the spring 124 abuts a spring slide plate 128 that is secured to the spring slide 122. Thus, the spring 124 biases the boom 110, relative to the barrel 108, for movement of the boom 110 to the right in FIG. 7, from the second, retracted position to the first, extended position. Movement of the boom 110 to the right beyond the extended position shown in FIG. 7 is prevented by a stop in the form of a rod 130 that extends through the boom 110 and the barrel 108 and is held, for sliding movement in slots formed in the barrel 108 and the boom 110 by connectors such as the thumb nuts 132. Specifically, the stop rod 130 is received in a vertically extending slot, indicated at 133 in FIG. 8, formed in the barrel 108 and is also received in an L-shaped slot, indicated at 134 in FIG. 7, formed in the boom 110. The boom 110 is partially supported by two supports in the form of pins 135 that extend through and are supported by the side walls of the barrel 108.

The cable 106 extends from the spool 104 over a first, rear pulley 136, through the slide mount 120, through the spring 124 and the spring slide 122, through the slide plate 128, through the plate 126, through the boom 110, through a stop plate 137 and over a second, front pulley 138 at the front tip of the boom 110. A hook (not shown) or the like is supported on the end of the cable 106, like the hook 72 in FIGS. 4 through 6. As described above in connection with the previous embodiment, the hook is adapted to engage a trailer coupler or, preferably, a connector secured to the trailer tongue, as in the first two embodiments. The operation of the apparatus 100 will now be described.

The barrel 108, preferably supported on the pivot support, is secured to a portion of a vehicle hitch. If supported on the pivot support, the barrel is pivoted about the pivot pin 118 to desired angular position where it is supported by the pivot locking pin 119 which engages a portion of the side plate 114 and a portion of the barrel 108. The operation of the apparatus is virtually the same as the operation of apparatus 50. Specifically, a connector, such as a hook (not shown) supported on and connected to the cable 106 is connected to the tongue of a trailer that is resting on the ground and, preferably, the connector of the cable 106 is connected to a connector, such as a hook eye, that is, in turn, connected to the trailer tongue. Once the cable is connected to the trailer tongue, the winch is activated to wind cable over the pulley 138 and onto the spool 104 of the winch 102. When enough cable 106 has been wound onto the spool 104, the portion of the trailer to which the cable 106 is connected will be positioned under the pulley 138 on the boom 110. As with previous embodiments, further winding of cable 106 onto the spool 104 will lift the trailer tongue up from the ground until a stop (not shown) that is connected to the cable 106 outside of the boom 110 abuts the stop plate 137. Because the boom 110 is extended while the trailer tongue is lifted, interference between the trailer tongue and the vehicle hitch is avoided. Once the stop on the cable 106 abuts the stop plate 137, further winding of cable 106 onto the spool 104 will cause the boom 110 to retract from the extended position shown in FIG. 7 to a retracted position (not shown) where the vertically extending slot 133 in the barrel 108 aligns with the short leg of the L-shaped slot 134 formed in the boom 110 whereupon the stop rod 130 can move and is moved downwardly to lock the boom 110 in the retracted position. With the boom 110 locked in the retracted position, the trailer will be positioned relative to a vehicle mounted hitch so that, as cable 106 is unwound from the spool 104, the trailer coupler will be lowered onto the hitch of the vehicle for connection thereto. The stop rod 130 can stay in the down or locking position where it prevents the force exerted on the boom 110 by the spring 124 from moving the boom from the retracted position to the extended position.

When it is desired to disconnect a trailer from a towing vehicle on which the apparatus 100 is mounted, the foregoing process is basically reversed. If the hook connected to the cable 106 has been removed from the connector attached to the trailer, it is attached or reattached to the connector and the winch 102 is activated to wind up cable 106 onto the spool 104 until the trailer coupler is raised off of the vehicle hitch and until the hook or other cable stop abuts the stop plate 137. Continued activation of the winch 102 will help release the stop rod 130 for movement from the second, boom locking position (not shown) to the first, boom sliding position shown in FIG. 7. With the stop rod 130 in the first position, the winch 102 is activated to unwind cable 106 from the spool 104 so that the boom 110, under the action of the spring 124, moves to the extended position (FIG. 7). When the boom 110 reaches the extended position, more cable 56 is unwound from the winch 102 until the trailer is lowered to the ground under the control of the winch 102. When the trailer reaches the ground, cable 106 is unwound to provide cable slack and the hook or other cable connector is disconnected from the trailer tongue or trailer coupler, thereby disconnecting the trailer from the towing vehicle.

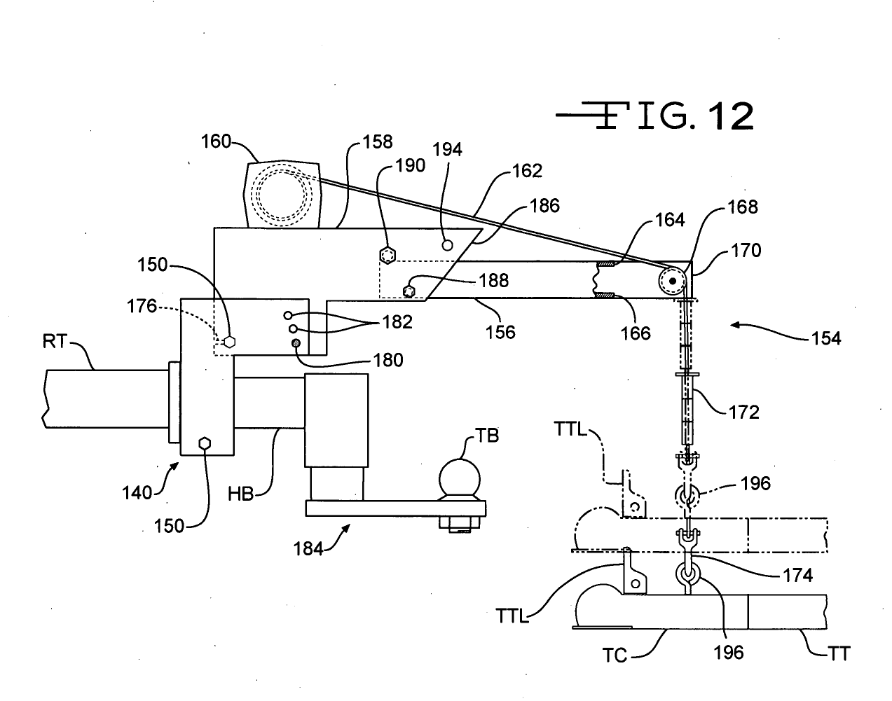

Referring now to FIG. 11, a universal bracket is indicated generally at 140. The bracket 140 is well suited for mounting apparatus, including apparatus according to the present invention, on a hitch bar HB which is normally received in a receiver tube (not shown). The bracket 140 comprises a first side plate 142 and a second side plate 144 and these are each mirror images of the other. Stabilizer elements 146 are provided on plate 142 and stabilizer elements 148 are provided on plate 144. The elements 146 and 148 are positioned on the plates 142 and 144 so that, when they are secured to a hitch bar HB as by fasteners 150 and 152, the elements 146 and 148 engage the hitch bar HB so as to prevent rotation of the bracket relative to the hitch bar HB and even to prevent any relative movement between the plates 142 and 144 on the one hand and the hitch bar HB on the other hand. The bracket 140 is adapted to be semi-permanently mounted on the hitch bar HB, a portion of which is typically received inside of an associated receiver tube (not shown) and held there with a clevis type pin. This mounting is done by bringing the plate 142 against one side of the hitch bar HB with one element 146 above and one element 146 below the hitch bar HB and bringing the plate 144 against the opposite side of the hitch bar HB with one element 148 above and one element 148 below the hitch bar HB. A pair of fasteners 150 is extended through openings above and below the elements 146 and 148 in the plates 142 and 144 and engaged with fasteners 152 to snugly and firmly hold the plates 142 and 144 in the positions described above. It is preferred that the fasteners 152 be nuts including means to prevent or resist rotation thereof in a manner that would loosen the fasteners 150 and 152, such as nylon locking nuts. The bracket 140 provides means for mounting apparatus on a hitch bar HB which is typically received in a receiver tube RT, without the need for drilling holes in or otherwise compromising the hitch bar HB.

Referring now to FIGS. 12 through 14, apparatus indicated generally at 154 is mounted on a bracket 140 corresponding generally with the bracket 140 shown in FIG. 11 which, in turn, is mounted on a hitch bar HB that is received in a receiver tube RT. The apparatus 154 comprises a boom 156 that is pivotally supported in a boom bracket 158 which, in turn, is supported on the universal bracket 140. A winch 160 is supported on and secured to the boom bracket 158. Cable 162 from the winch 160 passes through upper and lower cable slots 164 and 166 in the boom 156 and over a pulley 168 that is supported for rotation on a distal end 170 of the boom 156. A stop 172 is carried on the cable near a terminal hook 174. As described below in some detail, the stop 172 is operable to engage portions of the boom 156 near the distal end 170 adjacent to the slots 164 and 166 when cable 162 is wound onto the winch 160.

The boom bracket 158 shown in FIGS. 12 through 14 can be made from rectangular steel tube stock and is, preferably, hollow. The bracket 158 is provided with a slot 176 which is adapted to receive a shaft of the connector 150 while the shaft of another connector, 180 extends through one of three pairs of aligned apertures 182 in the plates of the universal bracket 140. In FIGS. 12 through 14, the connector 180 extends through the lowest pair of aligned apertures 182 to support the boom bracket in a generally horizontal orientation, as shown. This works well in conjunction with a drop hitch 184. With a straight hitch (not shown), the connector 180 may be positioned in the middle or the upper pair of aligned apertures 182 in the universal bracket so that a distal end 186 of the boom bracket 158 is positioned higher than is shown in FIGS. 12 through 14. It is preferred to provide in the apparatus 154 a mechanism for mounting the boom bracket 158 at different heights and/or different angular orientations relative to the bracket 140 or the hitch bar HB or both.

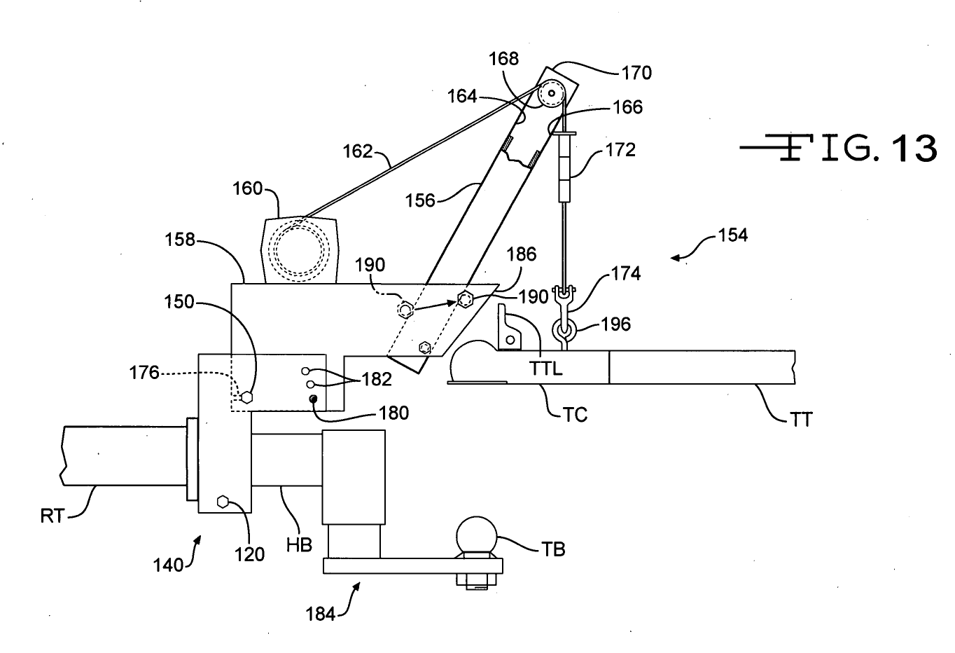

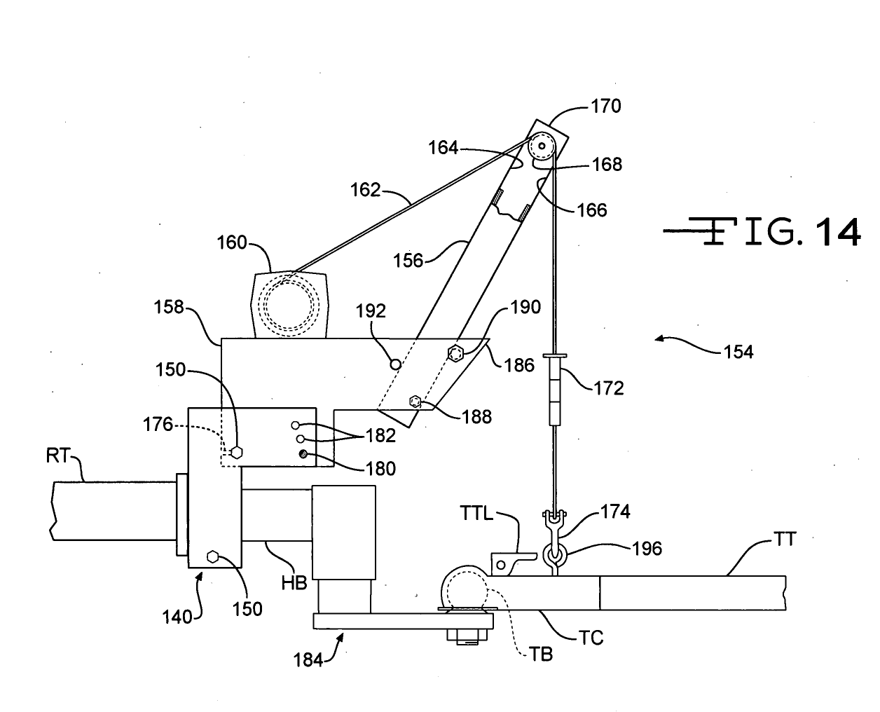

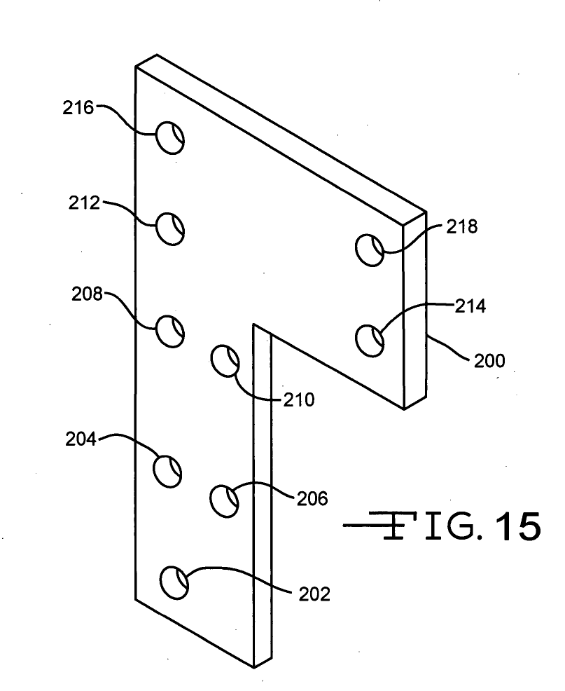

The boom 156 is mounted for pivotal movement relative to the boom bracket 158 on a connector 188 between a first position shown in FIG. 12 and a second position shown in FIGS. 13 and 14. The connector extends through the bracket 158 and the boom 156. A stop 190, which takes the form of a headed shaft in the apparatus 154, also extends through an aperture 192 in the bracket 158 and acts on the boom 156 to prevent it from rotating about the connector 188 (clockwise in FIGS. 12 through 14) from the first position, even when the cable 162 is supported on the pulley 168 and is supporting a substantial load. The stop 190 can be repositioned to extend through an aperture 194 to act on the boom 156 to prevent it from rotating about the connector 188 (clockwise in FIGS. 12 through 14) from the second position, even when the cable 162 is supported on the pulley 168 and it is supporting a substantial load.

In use, the apparatus 154 may be used to lift a trailer tongue TT and position it on a trailer ball TB as follows. If the boom is other than in the first position, it is repositioned to be in the first position and the boom stop 190 is positioned in the aperture 192 (FIG. 12). The connector at the end of the cable 162, which takes the form of the terminal hook 174 in the apparatus 154, is connected to a trailer tongue TT or to a connector associated with the trailer tongue such as a hook eye 196 connected to a trailer coupler TC on the trailer tongue TT (FIG. 12). Cable 162 may have to be unwound from the winch 160 in order for the connector hook 174 to reach the trailer connector 196. The winch 160 is operated to wind up cable 162. As cable 162 is wound onto the winch 160, the trailer tongue TT will be repositioned and repositioned again until the connector 196 is positioned directly beneath the pulley 168 (FIG. 12). As more cable 162 is wound onto the winch 160, the connector 196 and the trailer coupler TC and the trailer tongue TT will be raised up (FIG. 12). When the cable stop 172 reaches the end 170 of the boom 156 and more cable 162 is wound onto the winch 160, the boom 156 will pivot from the first position towards the second position, thereby relieving all pressure on the boom stop 190 in the aperture 192. As more cable 162 is wound onto the winch 160, the boom 156 will rotate past the second position and the stop 190 is then positioned in the aperture 194 and the winding up of cable 162 can be stopped. Cable 162 is then unwound from the winch 160. As cable 162 is unwound, the boom will pivot to the second position (FIG. 13) where the stop 190, which is positioned in the aperture 194, will prevent it from moving past the second position even as more cable 162 is unwound. So, as more cable 162 is unwound, the cable stop 172 and the connector 174 will be lowered, relative to the distal end 170 of the boom 156, thereby lowering the trailer tongue TT until enough cable has been unwound that the trailer coupler TC is positioned on the trailer ball TB (FIG. 14). A trailer tongue latch TTL can then be latched to latch the trailer onto the hitch ball HB.

Starting with the trailer coupler TC on the trailer ball TB, the trailer can be unhitched from the hitch 184 and positioned so that the trailer tongue TT is on the ground, just as easily as it was hitched to the hitch 184. The boom 156 is pivoted to the second position (FIG. 14) and the boom stop 190 is positioned in the aperture 194. The connector 174 is connected to the trailer tongue TT and, preferably, to the hook eye connector 196 (FIG. 14). The trailer tongue latch TTL is unlatched and cable 162 is wound onto the winch 160, thereby raising the trailer tongue until the cable stop 172 engages the distal end 170 of the boom 156 and, as more cable 162 is wound onto the winch 160, all pressure on the boom stop 190 is relieved and it is removed from the aperture 194 and repositioned in aperture 192. Cable 162 is now unwound from the winch 160 with the result that the boom will rotate from the second position towards the first position and into the first position where it will engage the boom stop 190 which will prevent the boom 156 from rotating past the first position. As more cable 162 is unwound from the winch 160, the connector 174 and the trailer tongue TT will be lowered relative to the distal end 170 of the boom 156 until the trailer tongue TT is lowered to the ground. As more cable 162 is unwound from the winch 160, there will be slack in the cable 162 to permit the removal of the connector 174 from the trailer.

Referring now to FIG. 15, a side plate 200 is shown. A pair of the side plates 200 may be substituted for the side plates 142 and 144 (FIG. 11) in a universal mounting bracket for supporting apparatus according to the present invention. A pair of the side plates 200 may be secured by bolts and nuts around a hitch bar (not shown in FIG. 15) for mounting apparatus according to the invention thereon. Plate mounting bolt holes 202, 204, 206, 208 and 210 are provided in the plate 200. It has been found that the plates 200 are well secured to a hitch bar when they are positioned one on each side of the bar and a lower bolt is positioned through bolt holes 202 in plates 200 and two upper bolts are positioned through bolt holes 204 and 206 and each bolt is secured with a nylon locking nut. Apparatus according to the invention, like the apparatus 50 or the apparatus 100 or the apparatus 154 can be mounted on the plates 200 using bolt holes 216 and 218 or bolt holes 212 and 214, depending on how high it is desired to mount the apparatus of the present invention. Apparatus mounted on the plates 200 can be mounted lower still if a lower mounting bolt is positioned in bolt holes 204 and upper mounting bolts are positioned in bolt holes 208 and 210 and each bolt is secured with a nylon locking nut.

Thus, it will be seen that the present invention is a device operable to position a trailer for attachment to a hitch ball on a towing vehicle, including lifting a trailer tongue above a hitch ball, without hitting the trailer tongue on the hitch ball, and repositioning the trailer tongue so that it may be lowered directly onto the hitch ball. The device is also operable to lift a trailer tongue of a trailer to detach it from a hitch ball and to reposition the trailer tongue so that it may be lowered to the ground without hitting the trailer tongue on the hitch ball. The invention is also a method for raising a trailer tongue above a hitch ball, repositioning the trailer tongue and lowering the trailer tongue onto the hitch ball for connecting the trailer to the towed vehicle. It is also a method for lifting a trailer tongue to disconnect a trailer from a hitch ball, repositioning the trailer tongue and lowering the trailer tongue to the ground.

According to the invention, the device includes a base or a bracket for mounting the device to a towing vehicle, a cable spool for winding cable onto and off of, preferably present as part of a motorized winch, a boom supported relative to said base or bracket and a cable support, preferably in the form of a pulley, mounted on the boom. The boom is mounted for movement between a first, hitch clearing position and a second, trailer connecting or disconnecting position. When the boom is in the first position, the cable support is operable to support the cable so that, when a load such as a trailer is connected to a free end of the cable and cable is wound onto or off of the spool, the load can be raised and lowered without the load interfering with a vehicle hitch associated with the vehicle. When the boom is in the second position, the cable support is operable to support the cable so that, when a load such as a trailer is connected to a free end of the cable and cable is wound onto or off of the spool, the trailer can be raised from and lowered to a position where a trailer coupler can be connected to and disconnected from a vehicle hitch. In two embodiments, the boom is biased from one position to the other position. In a preferred embodiment, the boom is biased towards the first position from the second position. Preferably, the device includes means for supporting the boom in more than one position. The device may include pivot means for mounting the boom relative to the base or the bracket for movement between first and second positions or it may include means supporting the boom for longitudinal movement between first and second positions. In the case where the boom is pivotally supported, it can be supported to pivot about a vertical axis or about a horizontal axis. When the boom is supported to pivot about a horizontal axis, the cable support moves in an arc when the boom pivots and that arc is in a plane that is oriented vertically.

Although a motorized winch is illustrated, any winch including a manually operated winch may be employed in a device according to the invention. As a cable support, a rotatably mounted pulley is preferred although a roller or a shaft or any other device that can serve to redirect the tension in a cable can be used.

I claim:

1. A device for raising a trailer and positioning it on a hitch on a vehicle, the device comprising:
a support for supporting the device on the vehicle,
cable having a first end and a second end,
a cable spool onto which said cable can be wound and from which said cable can be unwound,
a connector connected to said second end of said cable,
a boom supported on said support for movement between a first position and a second position and
a cable support mounted on said boom for movement therewith between a first position and a second position,
wherein, when said boom and said cable support are in the first positions and the connector is connecting said cable to the trailer, the device is operable to raise and lower the trailer without it interfering with the hitch and when said boom and said cable support are in the second positions and the connector is connecting said cable to the trailer, the device is operable to raise and lower the trailer onto and off of the hitch.

2. The device claimed in claim 1 wherein said boom pivots from said first position to said second position.

3. The device claimed in claim 2 wherein said boom pivots about an axis that is substantially horizontal when the device is supported on the vehicle.

4. The device claimed in claim 3 wherein said cable support moves in an arcuate path as said boom pivots from said first position to said second position.

5. The device claimed in claim 1 wherein the weight of a load connected to the cable connector biases the boom towards the second position.

6. The device claimed in claim 2 wherein the weight of a load connected to the cable connector biases the boom towards the second position.

7. The device claimed in claim 3 wherein the weight of a load connected to the cable connector biases the boom towards the second position.

8. The device claimed in claim 4 wherein the weight of a load connected to the cable connector biases the boom towards the second position.

9. The device claimed in claim 1 which further comprises a cable stop secured to said cable that is operable to engage the boom when said cable is being wound onto said spool so that further winding of said cable onto said spool moves said boom towards said first position.

10. The device claimed in claim 1 wherein said boom reciprocates between said first position and said second position.

11. The device claimed in claim 10 wherein said boom is biased towards said first position.

12. The device claimed in claim 11 which further comprises a stop for locking said boom in said second position.

13. The device claimed in claim 11 which further comprises a stop plate associated with said boom and a stop on said cable that cooperates with said stop plate to move said boom from said first position to said second position, against the bias, when said cable is being wound onto said spool.

14. The device claimed in claim 13 wherein said biased boom moves from said second position to said first position, with the bias, when said locking stop is not engaged and cable is unwound from said spool.

15. The device claimed in claim 1 wherein said spool is selectively powered by an electric motor.
